(19) United States
(12) Patent Application Publication
(10) Pub. No.: US 2014/0229310 A1
(43) Pub. Date: Aug. 14, 2014

(54) DISPLAY DEVICE CONFIGURATION USING A DISPLAYED IMAGE

(71) Applicant: THOMSON LICENSING, Issy de Moulineaux (FR)

(72) Inventors: Gregory D. GUDORF, San Diego, CA (US); Manuele WAHL, Boulogne (FR); Saurabh MATHUR, Bangalore (IN)

(73) Assignee: THOMSON LICENSING, Issy de Moulineaux (FR)

(21) Appl. No.: 14/170,486

(22) Filed: Jan. 31, 2014

Related U.S. Application Data
(60) Provisional application No. 61/762,821, filed on Feb. 8, 2013.

(51) Int. Cl. G06Q 30/06; G06T 11/00

(52) U.S. Cl. CPC G06Q 30/0601; G06T 11/001
USPC 705/26.1

(57) ABSTRACT

The disclosure presents a plurality of images of an item previously purchased by a user from an electronic commerce vendor. Each of the images has a visual characteristic that is modified from the original image. A user compares a physical version of the item purchased against such display images to select the image that most represents how the physical item really looks. A visual calibration metric is determined from the selected image and a modification, based on the calibration metric, is applied to all subsequently displayed images of items available from an electronic commerce vendor.

This application claims benefit under 35 U.S.C. §119(e) of U.S. Provisional Application 61/762,821 that was filed on Feb. 8, 2013.

### TECHNICAL FIELD

The disclosure is related towards a method and apparatus for displaying images, and more particularly to a method and apparatus calibrating displayed images for items available through an electronic commerce vendor.

### BACKGROUND

When a user purchases an item through an electronic commerce vendor such as AMAZON, WAL-MART, NORDSTROM, and the like, the user will typically receive the purchased item at their place of business or home. However, a characteristic of the received item may be different than the characteristic viewed on the electronic commerce website. For example, if the purchased item is an article of clothing, the color of the article of clothing in person can be different than the image shown on the website of the electronic commerce vendor. This variation between the image of the purchased item and the real color of the purchased item may lead a user to want to return the item to electronic commerce vendor. These returns result in the profit margins of the electronic commerce vendors being diminished by a significant amount.

A vendor can provide high quality images of items to be purchased where each image of the vendor is presented with a high dynamic color gamut and resolution. The problem with the presentation of such images is that the user may have a display device which is incapable of taking advantage of such high quality images. In addition, different users perceive the same color in different ways. For example, one user may be color blind while a second user may not be able to distinguish between different shades of a color.

Thus, a method and apparatus is needed to help account for these differences in how people perceive an item's characteristics (e.g., the color of the item) on a display device and how the same item looks in real life.

### BRIEF SUMMARY

One embodiment of the disclosure presents a plurality of images of an item previously purchased by a user from an electronic commerce vendor. Each of the images has a visual characteristic that is modified from the original image. A user compares a physical version of the item purchased against such display images to select the image that most represents how the physical item really looks. A visual calibration metric is determined from the selected image and a modification, based on the calibration metric, is applied to all subsequently displayed images of items available from an electronic commerce vendor.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 shows a block diagram of an embodiment of a system for delivering images of items to a user in accordance with the principles of the present disclosure;

FIG. 2 shows a block diagram of an embodiment of a server in accordance with the principles of the present disclosure;

FIG. 3 shows a block diagram of an embodiment of a playback device in accordance with the principles of the present disclosure;

FIG. 4 presents a flow chart of an embodiment of the present disclosure for modifying different images of items for purchase from an electronic vendor; and

FIG. 5 presents a representation of a user interface that presents multiple modified images of the same original image in accordance with the principles of the present disclosure.

It should be understood that the drawing(s) is for purposes of illustrating the concepts of the disclosure and is not necessarily the only possible configuration for illustrating the disclosure.

### DETAILED DESCRIPTION OF THE INVENTION

It should be understood that the elements shown in the Figures can be implemented in various forms of hardware, software or combinations thereof. Preferably, these elements are implemented in a combination of hardware and software on one or more appropriately programmed general-purpose devices, which can include a processor, memory and input/output interfaces. Herein, the phrase “coupled” is defined to mean directly connected to or indirectly connected with through one or more intermediate components or signal paths. Such intermediate components can include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes that can be substantially represented in computer readable media and so executed by a computer or processor, whether or not such computer or processor is explicitly shown. The computer readable media and code written on can be implemented in a transitory state (signal) and a non-transitory state (e.g., on a tangible medium such as CD-ROM, DVD, Blu-Ray, Hard Drive, flash card, or other type of tangible storage medium).

The functions of the various elements shown in the figures can be provided through the use of dedicated hardware as well as hardware capable of executing software in association with appropriate instructions. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read only memory (“ROM”) for storing software, random access memory (“RAM”), and nonvolatile storage.

Other hardware, conventional and/or custom, can also be included. Similarly, any switches shown in the figures are conceptual only. Their function can be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

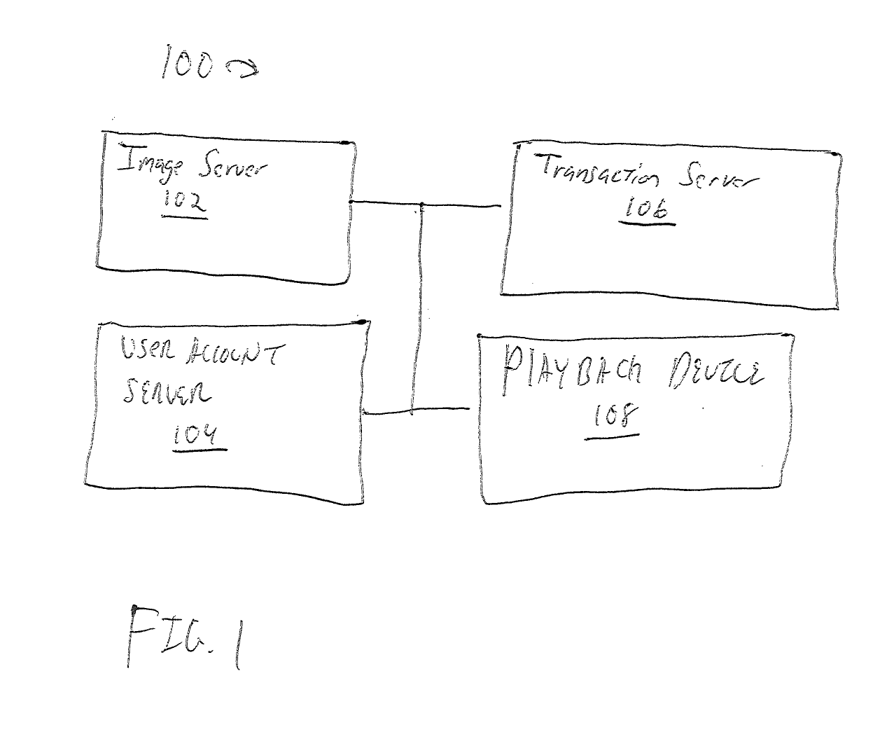

FIG. 1 shows a block diagram of an embodiment of a system 100 for delivering images of items from an electronic commerce vendor to a user in accordance with the principles of the present disclosure where each of the display components are coupled to each other using a network connection, wired connection, wireless connection, and the like. Image server 102 is configured to supply images of items to playback device 108. The transactional data corresponding to when a user purchases items come from transaction server 106 that provides a user with the ability to purchase items from the electronic commerce vendor. Ideally, transaction server 106 will authorize a purchase of selected items of a user and coordinate the delivery of such items to an address specified by the user. Transactional server 106 can also be configured to retain transactional data of items previously purchased by a user.

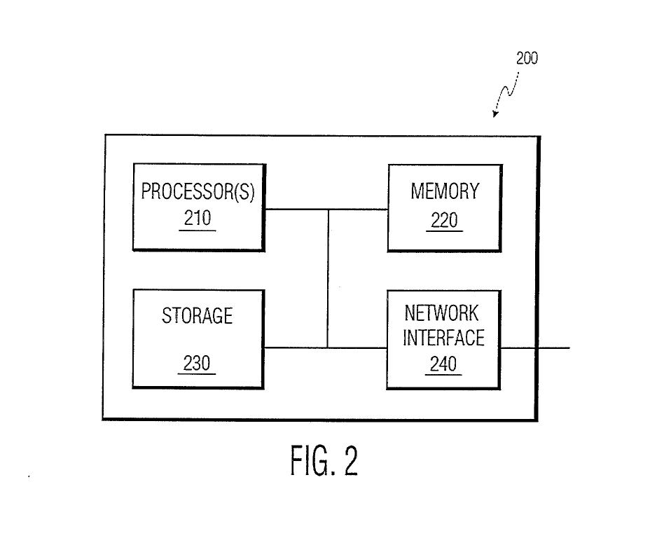

Referring back to image server 102, a database can be implemented in the memory 220 or storage 230 (FIG. 2) of image server 102 that stores images of items available from an electronic commerce vendor. The database contains various information about the items including the price and characteristics of such items. Image server 102 can be configured to modify the images of the same item by adjusting the chrominance, luminance, RGB values, CMYK, and the like values of an item.

User account server 104 can be configured as a server to retain information about a user's payment information, address book of places to deliver purchased items, transactional information of previous user purchases from an electronic commerce vendor, and other information that can be used for electronic commerce transactions.

Playback device 108 can be configured to provide a user with the ability to select an image of items available from an electronic commerce vendor, purchased items from via image server 102 and transactional server 108, and search for items available from the electronic commerce vendor. Playback device 108 can be a computer, video game system, display device, tablet, phone, smart watch, set top box, electronic book reader, digital audio music player, and the like.

FIG. 2 depicts an exemplary server 200 that can be used for implementing any one of the media server 102, user account server 104, transaction server 106, digital locker 110, and the like. The server, includes one or more processors 210, memory 220, storage 230, and a network interface 240. Each of these elements will be discussed in more detail below.

The processor 210 controls the operation of the server 200. The processor 210 runs the software that operates the server as well as provides the functionality of the software required to operate any one of the servers (102, 104, 106, 110). The processor 210 is connected to memory 220, storage 230, and network interface 240, and handles the transfer and processing of information between these elements. The processor 210 can be general processor or a processor dedicated for a specific functionality. In certain embodiments there can be multiple processors.

The memory 220 is where the instructions and data to be executed by the processor are stored. The memory 220 can include volatile memory (RAM), non-volatile memory (EEPROM), or other suitable media. Memory 220 can be configured to operate a database to support any one of the operations required for servers (102, 104, 106, 110) in accordance with the described principles under the direction of processor 210.

The storage 230 is where data is stored for the use of processor 210 in executing the described operations. Storage 230 can be magnetic media (hard drive), optical media (CD/DVD-Rom), or flash based storage. Storage 230 can be configured to operate a database to support any of the operations required for server (102, 104, 106, 110) in accordance with the described principles under the direction of processor 210. Storage 230 can also be configured to store information comporting to user account data, transaction data, information comporting to previous media asset transactions by a user, media assets, and the like.

Network interface 240 handles the communication of server 200 with other devices over a network. Examples of suitable networks include Ethernet networks, Wi-Fi enabled networks, cellular networks, and the like. Other types of suitable networks will be apparent to one skilled in the art given the benefit of the disclosure.

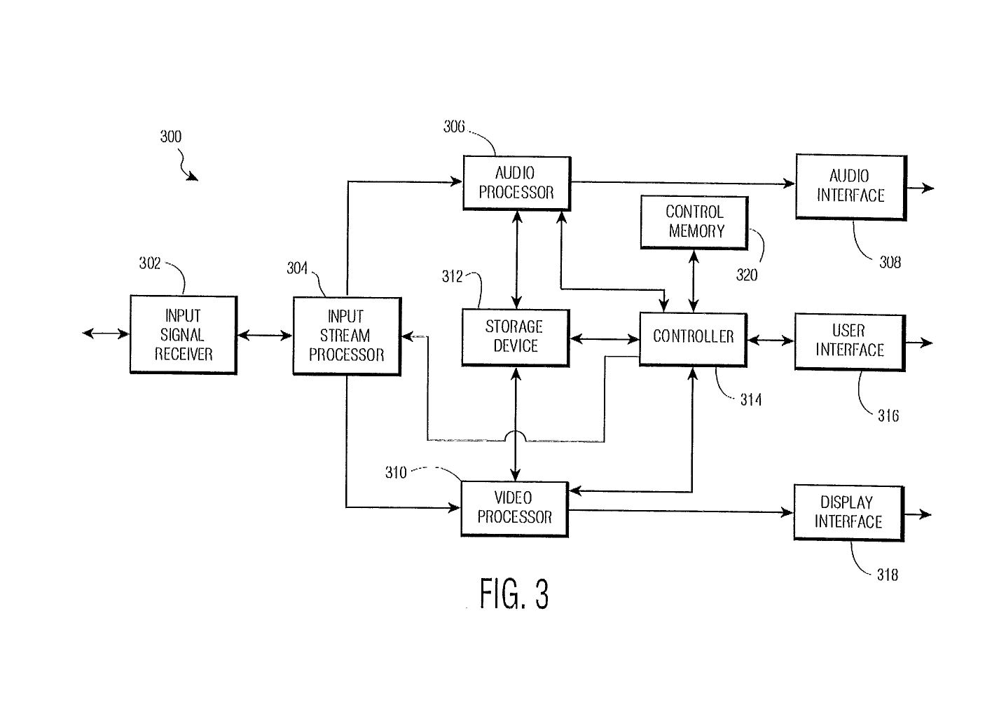

In the playback device 300 shown in FIG. 3, image information and corresponding information used for purchasing items are received via input signal receiver 302. The input signal receiver 302 can be one of several known receiver circuits used for receiving, demodulation, and decoding signals provided over one of the several possible networks including over the air, cable, satellite, Ethernet, fiber and phone line networks. The desired input signal can be selected and retrieved in the input signal receiver 302 based on user input provided through a control interface (not shown). The decoded output signal is provided to an input stream processor 304. The input stream processor 304 performs the final signal selection and processing, and includes separation of video content from audio content for the content stream. The audio content is provided to an audio processor 306 for conversion from the received format, such as compressed digital signal, to an analog waveform signal. The analog waveform signal is provided to an audio interface 308 and further to the display device 114 or an audio amplifier (not shown). Alternatively, the audio interface 308 can provide a digital signal to an audio output device or display device using a High-Definition Multimedia Interface (HDMI) cable or alternate audio interface such as via a Sony/Philips Digital Interconnect Format (SPDIF). The audio processor 306 also performs any necessary conversion for the storage of the audio signals.

The video output from the input stream processor 304 is provided to a video processor 310. The video signal can be one of several formats. The video processor 310 provides, as necessary a conversion of the video content, based on the input signal format. The video processor 310 also performs any necessary conversion for the storage of the video signals.

Storage device 312 stores audio and video content received at the input. The storage device 312 allows later retrieval and playback of the content under the control of a controller 314 and also based on commands, e.g., navigation instructions such as fast-forward (FF) and rewind (Rew), received from a user interface 316. The storage device 312 can be a hard disk drive, one or more large capacity integrated electronic memories, such as static random access memory, or dynamic random access memory, or can be an interchangeable optical disk storage system such as a compact disk drive or digital video disk drive. In one embodiment, the storage device 312 can be external and not be present in the system.

The converted video signal, from the video processor 310, either originating from the input or from the storage device 312, is provided to the display interface 318. The display interface 318 further provides the display signal to a display device of the type described above. The display interface 318 can be an analog signal interface such as red-green-blue (RGB) or can be a digital interface such as high definition multimedia interface (HDMI).

Controller 314 is interconnected via a bus to several of the components of the device 300, including the input stream processor 302, audio processor 306, video processor 310, storage device 312, and a user interface 316. The controller 314 manages the conversion process for converting the input stream signal into a signal for storage on the storage device or for display. The controller 314 also manages the retrieval and playback of stored content. Furthermore, as will be described below, the controller 314 performs searching of content, either stored or to be delivered via the delivery networks described above. The controller 314 is further coupled to control memory 320 (e.g., volatile or non-volatile memory, including random access memory, static RAM, dynamic RAM, read only memory, programmable ROM, flash memory, EPROM, EEPROM, etc.) for storing information and instruction code for controller 214. Further, the implementation of the memory can include several possible embodiments, such as a single memory device or, alternatively, more than one memory circuit connected together to form a shared or common memory. Still further, the memory can be included with other circuitry, such as portions of bus communications circuitry, in a larger circuit.

User interface 316 of the present disclosure can employ an input device that moves a cursor around the display, which in turn causes the content to enlarge as the cursor passes over it. In one embodiment, the input device is a remote controller, with a form of motion detection, such as a gyroscope or accelerometer, which allows the user to move a cursor freely about a screen or display. In another embodiment, the input device is controllers in the form of touch pad or touch sensitive device that will track the user's movement on the pad, on the screen. In another embodiment, the input device could be a traditional remote control with direction buttons.

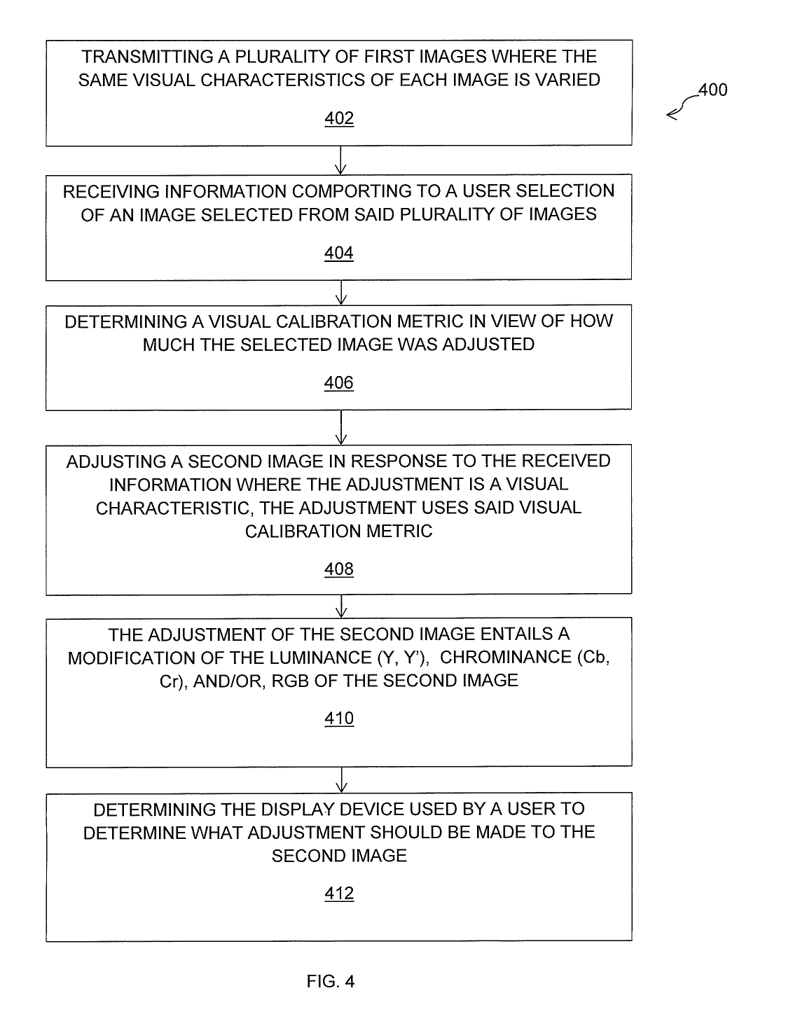

FIG. 4 presents a flow chart of 400 of an exemplary embodiment for modifying different images of items for purchase from an electronic vendor. The method will present multiple images of item that a user previously purchased from an electronic vendor. The exemplary embodiment has each image varied in such a way where the visual characteristics of such images (such as the luminance, chrominance, RGB, and the like) of the images changes from image to image. For example, each image is presented with a different color shade, brightness is varied from image to image, and the like. When an image is selected by a user, a visual calibration metric is determined which comports to the changes made to a selected image. This visual calibration metric can then be applied to all images transmitted by image server 102.

In step 402, image server 102 transmits a plurality of first images where the same visual characteristic for each image is changed, and each image is generated from the same original image. Preferably, the image used comports to an item previously bought from the electronic vendor and physically delivered to a user. The user can then use such the physical item as a reference against the images shown on a display device to select the presented item that represents the best match for the physical version of the item. Ideally, the modified images will comport to a YCbCr color space, Y′CbCr color space, RGB color space, and CMYK color space, and the like where respective luminance, chrominance, and the like can be modified from image to image. Note, optionally, multiple modifications made to an original image, for example the luminance can be modified from an original image for one of the plurality of images while the chrominance can be modified from an original image for a second one of the plurality of images.

Step 404 lets a user select an image from the presented images where the user can compare the physical item against the presented images. The selection of what image a user selected is received by image server 102. Image server 102 determines from the received information the manner in which a selected image was changed from an original image. In an illustrative example, the luminance component for each image shown in step 402 is modified by a certain amount. When a user selects a modified image with a changed luminance, the image server 102 knows how the luminance value of the selected image was changed whereby image server 102 can apply such a change to subsequently generated and transmitted images.

In step 406, this varied visual component of an selected image can be used to determine a visual calibration metric which can be used to change a characteristic (e.g., Y, Y′, Cb, Cr, and the like components) of subsequently rendered images. The calibration metric, in step 408, can be used to modify a visual characteristic of all subsequently rendered images As previously stated, such visual characteristics can be the chrominance, luminance, or other visual elements of such rendered images. Preferably, the subsequent images comport to items that are available for purchase through the electronic vendor.

In step 410, the adjustment of the second image entails a modification to the chrominance, luminance, and the like of an image to be rendered. Optionally, in step 412, the display device used by a user is determined, where the modification to subsequent images are made in view of such a determination. For example, if it known that a particular display device tends to have a high brightness for displayed images, the display of all subsequent images will be modified to account for such a brightness. This determination can be made by querying a playback device 108 and requesting attributes about a coupled display device including the model, display technology, and other attributes associated with the display device.

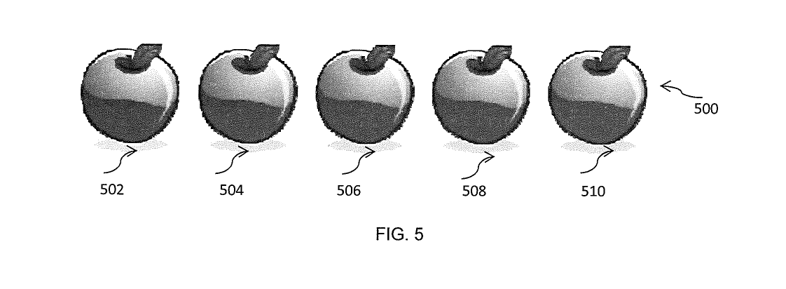

FIG. 5 presents a representation of a user interface 500 that presents multiple modified images of the same original image in accordance with the principles of the present disclosure. A number of images 502, 504, 506, 508, and 510 of an original image of an item that was previously purchased from an electronic retailer (an apple in this case) where each presented image has a visual characteristic modified in accordance with the principles. Based on what picture is selected by a user, a visual characteristic can be developed with is applied to the display of subsequent images of items to purchase. Other examples of user interfaces are possible in accordance with the disclosed principles.

1. A method of adjusting images comprising the steps of:
transmitting a plurality of first images where at least one visual characteristic of each image is varied and said plurality of first images representing an image of a first item;
receiving information indicating a user selection of at least one of the plurality of first images;
adjusting at least one visual characteristic of a second image in response to the received information; and
transmitting said second image.

2. The method of claim 1 where said at least one visual characteristic that is varied is at least one of a luminance component of said image of said first item and a chrominance component of said image of said first item.

3. The method of claim 2 where said luminance and chrominance components comport to at least one of a YCbCr color space, Y′CbCr color space, RGB color space, and CMYK color space.

4. The method of claim 3 where at least one of said Y, Y′, Cb, and Cr components are varied when generating said plurality of first images.

5. The method of claim 1 where said user selection is used to determine a visual calibration metric that is used for generating said second image.

6. The method of claim 5 where said visual calibration metric is used to adjust at least one of a Y, Y′, Cb, and Cr component comporting to said second image.

7. The method of claim 1 comprising an additional step of determining a display device being used and adjusting said visual characteristic of said second image in response to said determination step.

8. The method of claim 1 where said first item was previously purchased by a user.

9. The method of claim 8 where said second image is of an item available through an electronic commerce vendor.

10. A method of adjusting an adjusting a display device comprising the steps of:
displaying a plurality of first images where at least one visual characteristic of each image is varied and said plurality of first images comport to an image of an first item;
adjusting at least one visual characteristic of a second image in response to a user selection of an image from said plurality of first images; and
displaying said adjusted second image.

11. The method of claim 10 where said at least one visual characteristic that is varied is at least one of a luminance component of said image of said item and a chrominance component of said image of said item.

12. The method of claim 11 where said luminance and chrominance components comport to at least one of a YCbCr color space, Y′CbCr color space, RGB color space, and CMYK color space.

13. The method of claim 12 where at least one of said Y, Y′, Cb, and Cr components are varied when generating said plurality of images.

14. The method of claim 13 where said user selection is used to determine a visual calibration that is used for generating said second image.

15. The method of claim 10 where said visual calibration is used to adjust at least one of a Y, Y′, Cb, and Cr component comporting to said second image.

16. The method of claim 10 comprising an additional step of determining a display being used and adjusting said visual characteristic of said second image in response to said determination step.

17. The method of claim 10 where said first item was previously purchased by a user.

18. The method of claim 17 where said second image is of an item available through an electronic commerce vendor.

19. An apparatus comprising the steps of:
a display device that displays plurality of first images where at least one visual characteristic of each image is varied and said plurality of first images comport to an image of an first item;
a processor configured to adjust at least one visual characteristic of a second image in response to a user selection of an image from said plurality of first images; and
said display device displays said adjusted second image.
